(19) United States
(12) Patent Application Publication
(10) Pub. No.: US 2026/0155422 A1
(43) Pub. Date: Jun. 4, 2026

(54) BATTERY ASSEMBLY DEVICE, BATTERY ASSEMBLING METHOD, AND BATTERY ASSEMBLING SYSTEM

(71) Applicant: SK ON CO., LTD., Seoul (KR)

(72) Inventors: Yun U CHANG, Daejeon (KR); Eun Ho KO, Daejeon (KR); Jeong Been KIM, Daejeon (KR); Yong Hun JUNG, Daejeon (KR)

(21) Appl. No.: 18/963,760

(22) Filed: Nov. 29, 2024

(30) Foreign Application Priority Data
Nov. 30, 2023 (KR) 10-2023-0170606

(51) Int. Cl. H01M 10/04; H01M 50/507; H01M 50/516

(52) U.S. Cl. CPC H01M 10/0404; H01M 50/516; H01M 50/507

(57) ABSTRACT

A battery assembly device of the present disclosure includes a first work station configured to couple, using a first fixing member, an endplate and a busbar assembly of the battery stack, a second work station configured to couple, using a second fixing member, at least one of the endplate or the busbar assembly of the battery stack transported from the first work station and an upper cover of the battery stack, and a first rework station configured to, when an abnormality is detected in a coupling state of the first fixing member and the second fixing member, remove the fixing member with the abnormality detected, and to input it into the first work station or the second work station.

### CROSS-REFERENCE TO RELATED PATENT APPLICATION

This application claims priority under 35 U.S.C. § 119 (a) to Korean patent application number 10-2023-0170606, filed on Nov. 30, 2023, the disclosure of which is incorporated by reference herein in its entirety.

### BACKGROUND

### 1. Technical Field

The disclosure relates to a secondary battery, and specifically to a battery assembly device.

### 2. Description of the Related Art

Secondary batteries may be charged and discharged multiple times. Due to their economical and eco-friendly characteristics, the secondary batteries are widely used in various industries.

The secondary batteries may be divided into battery cells, battery modules, or the like, depending on the unit. A battery module may include a plurality of battery cells. A battery stack in which the plurality of battery cells are stacked may be manufactured as the battery module through an assembly process of coupling a cover or the like using multiple fixing members.

On the other hand, due to the malfunction of a battery assembly device that performs the assembly process, a process error, or the like, an abnormality may occur in a coupling state of the fixing member. In this case, the battery assembly device may be shut down and restarted after the fixing member is manually fastened again, but the problem of decreasing manufacturing productivity may occur due to the shutdown of the battery assembly device. Accordingly, there is a desire for a method of improving the manufacturing productivity of a battery module.

### SUMMARY

An object to be achieved by the present disclosure is to provide a battery assembly device that improves the manufacturing productivity of a battery module.

The present disclosure may be widely applied to the field of green technology such as solar power generation and wind power generation. In addition, the present disclosure may be applied to eco-friendly devices such as electric vehicles and hybrid vehicles to prevent climate change by suppressing air pollution and greenhouse gas emissions.

A battery assembly device of the present disclosure includes a first work station configured to couple an endplate to a busbar assembly using a first fixing member, wherein the endplate is disposed on one side of a battery stack in which a plurality of battery cells are stacked and the busbar assembly is disposed at least on one of the other sides of the battery stack, a second work station configured to couple, using a second fixing member, at least one of the endplate or the busbar assembly of the battery stack transported from the first work station to an upper cover disposed in an upper part of the battery stack, and a first rework station configured to, when an abnormality is detected in a coupling state of at least one fixing member of the first fixing member or the second fixing member, remove the first or second fixing members having the abnormality detected from the battery stack transported from the first work station or the second work station and input the battery stack into the first work station or the second work station.

In an embodiment, the coupling state may include at least one of a fastening height, a fastening torque, or a fastening angle.

In an embodiment, the first work station may include a first assembly station configured to couple the endplate to the busbar assembly by using the first fixing member, and a first inspection station configured to inspect the coupling state of the first fixing member of the battery stack transported from the first assembly station.

In an embodiment, the first work station may further include a welding station configured to perform a welding operation to weld the busbar assembly so that the battery stack and the busbar assembly are coupled together when no abnormality is detected in the coupling state of the first fixing member and not perform the welding operation when an abnormality is detected in the coupling state of the first fixing member.

In an embodiment, the first work station may input the battery stack into the second work station when no abnormality is detected in the coupling state of the first fixing member, and may input the battery stack into the first rework station when an abnormality is detected in the coupling state of the first fixing member.

In an embodiment, the second work station may include a second assembly station configured to couple at least one of the endplate or the busbar assembly to the upper cover by using the second fixing member, and a second inspection station configured to inspect the coupling state of the second fixing member of the battery stack transported from the second assembly station.

In an embodiment, each of the first assembly station and the second assembly station may include a sensor configured to detect whether a fixing member exists at a fastening position of the first or the second fixing members, in which an abnormality is detected, and a fastening station configured to perform a fastening operation to fasten a corresponding fixing member in the fastening position when the fixing member inserted in advance does not exist at the fastening position.

In an embodiment, the fastening station may bypass the battery stack without performing the fastening operation and input the battery stack into the first rework station when the fixing member exists at the fastening position.

In an embodiment, the first rework station may include a first sub-rework station configured to, when an abnormality is detected in the coupling state of the first fixing member, remove, from the battery stack transported from the first work station, the first fixing member having the abnormality detected, and to input, into the first work station, the battery stack from which the first fixing member having the abnormality detected is removed, and a second sub-rework station configured to, when an abnormality is detected in the coupling state of the second fixing member, remove, from the battery stack transported from the second work station, the second fixing member having the abnormality detected, and to input, into the first work station or the second work station, the battery stack from which the second fixing member having the abnormality detected is removed.

In an embodiment, the battery assembly device may further include a reversing station configured to reverse the battery stack so that a lower surface of the battery stack transported from the second work station faces upward, and a third work station configured to couple, using a third fixing member, at least one of the endplate or the busbar assembly to a lower cover disposed in an upper part of the reversed battery stack.

In an embodiment, the battery assembly device may further include a second rework station configured to, when an abnormality is detected in a coupling state of the third fixing member, remove, from the reversed battery stack, the third fixing member having the abnormality detected, and to input, into the third work station, the reversed battery stack from which the third fixing member having the abnormality detected is removed.

In an embodiment, the third work station may include a third assembly station configured to couple, using the third fixing member, at least one of the endplate or the busbar assembly to the lower cover, and a third inspection station configured to inspect the coupling state of the third fixing member of the battery stack transported from the third assembly station.

In an embodiment, the third assembly station may include a sensor configured to detect whether a fixing member exists at a fastening position of the third fixing member having an abnormality detected, and a fastening station configured to perform a fastening operation to fasten the third fixing member at the fastening position when no fixing member exists at the fastening position.

In an embodiment, the fastening station may bypass the battery stack without performing the fastening operation and input the battery stack into the second rework station when the fixing member inserted in advance exists at the fastening position.

A method for assembling a battery of the present disclosure includes coupling an endplate disposed on one side of a battery stack in which a plurality of battery cells are stacked to a busbar assembly disposed at least on one of the other sides of the battery stack using a first fixing member, coupling at least one of the endplate or the busbar assembly of the battery stack transported from the first work station to an upper cover disposed in an upper part of the battery stack using a second fixing member, detecting an abnormality in a coupling state of one or both of the first and second fixing members, removing the battery stack from one or both of the first and second fixing members, removing one or both of the first and second fixing members based on where the abnormality is detected and inputting the battery stack into one or both of the first and second fixing members when no abnormality is detected.

A system for assembling a battery of the present disclosure includes first means for coupling an endplate disposed on one side of a battery stack in which a plurality of battery cells are stacked to a busbar assembly disposed at least on one of the other sides of the battery stack, second means for coupling at least one of the endplate or the busbar assembly of the battery stack transported from the first work station to an upper cover disposed in an upper part of the battery stack and means for detecting an abnormality in a coupling state of one or both of the first and second means for coupling, wherein the coupling state comprises at least one of a fastening height, a fastening torque, or a fastening angle of the of a fixing member of the first or second means for coupling.

According to an embodiment of the present disclosure, a battery assembly device that improves the manufacturing productivity of a battery module may be provided.

According to an embodiment of the present disclosure, a battery assembly device may automate rework of an assembly process.

According to an embodiment of the present disclosure, a shutdown of a battery assembly device due to a defective assembly of a battery module may be minimized.

### BRIEF DESCRIPTION OF THE DRAWINGS

FIG. 1 is a block diagram illustrating a battery assembly device according to an embodiment.

FIG. 2 is a diagram illustrating a battery stack input into a first work station according to an embodiment.

FIG. 3 is a diagram illustrating a coupling between a battery stack and a busbar assembly according to an embodiment.

FIG. 4 is a diagram illustrating a coupling between a battery stack and an upper cover according to an embodiment.

FIGS. 5 and 6 are diagrams illustrating a coupling between a reversed battery stack and a lower cover according to embodiments.

### DETAILED DESCRIPTION

The structural or functional descriptions of examples disclosed in the present specification or application are merely illustrated for the purpose of explaining examples according to the technical principle of the present invention, and examples according to the technical principle of the present invention may be implemented in various forms in addition to the examples disclosed in the specification of application. In addition, the technical principle of the present invention is not construed as being limited to the examples described in the present specification or application.

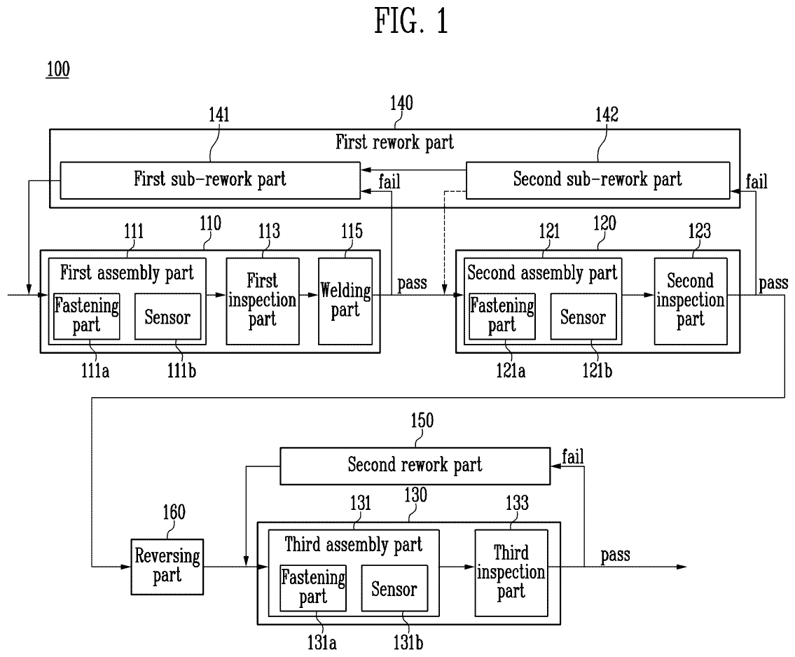

FIG. 1 is a block diagram illustrating a battery assembly device according to an embodiment.

Referring to FIG. 1, a battery assembly device 100 may produce a battery module by coupling a battery stack and a module member (e.g., a busbar assembly, an upper cover, a lower cover, or the like) using a fixing member. For example, the battery assembly device 100 may be a manufacturing equipment that performs an assembly process of the battery module. When an abnormality occurs in a coupling state of the fixing member, the battery assembly device 100 may remove the abnormal fixing member and perform coupling with a new fixing member. In an embodiment, the coupling state may include at least one of a fastening height, a fastening torque, or a fastening angle of the fixing member.

In an embodiment, the battery assembly device 100 may include a first work station 110, a second work station 120, and a first rework station 140. In an embodiment, the battery assembly device 100 may further include at least one of a reversing station 160, a third work station 130, or a second rework station 150.

The first work station 110 may couple the battery stack and the busbar assembly using a first fixing member. Here, the first fixing member may be a bolt, a screw, or the like.

The first work station 110 may input the battery stack into the second work station 120 or the first rework station 140 depending on a coupling state of the first fixing member. For example, the first work station 110 may input the battery stack into the second work station 120 when no abnormality exists in the coupling state of the first fixing member (pass). When an abnormality exists in the coupling state of the first fixing member (fail), the first work station 110 may input the battery stack into the first rework station 140. In an embodiment, a discharge port of the first work station 110 may be connected to input ports of the second work station 120 and the first rework station 140.

The second work station 120 may couple the battery stack transported from the first work station 110 and the upper cover by using a second fixing member. Here, the second fixing member may be a bolt, screw, or the like.

The second work station 120 may input the battery stack into the reversing station 160 or the first rework station 140 depending on a coupling state of the second fixing member. For example, the second work station 120 may input the battery stack into the reversing station 160 when no abnormality exists in the coupling state of the second fixing member (pass). When an abnormality exists in the coupling state of the second fixing member (fail), the second work station 120 may input the battery stack into the first rework station 140. In an embodiment, the discharge port of the first work station 110 may be connected to input ports of the reversing station 160 and the first rework station 140.

When an abnormality is detected in the coupling state of at least one of the first fixing member or the second fixing member, the battery stack may be transported to the first rework station 140 from the first work station 110 or the second work station 120. The first rework station 140 may remove, from the transported battery stack, the fixing member with the abnormality detected. The first rework station 140 may input the battery stack into the first work station 110 or the second work station 120.

In an embodiment, the first rework station 140 may include a first sub-rework station 141 and a second sub-rework station 142. The first sub-rework station 141 may remove the first fixing member in which the abnormality is detected. The second sub-rework station 142 may remove the second fixing member in which the abnormality is detected. For example, the first sub-rework station 141 and the second sub-rework station 142 may be embodied as an automated robot or workbench that removes the fixing member.

In an embodiment, the battery stack may be transported from a discharge port to an input port connected to the discharge port. A discharge port of the second sub-rework station 142 and the discharge port of the first work station 110 may be connected to an input port of the first sub-rework station 141. A discharge port of the first sub-rework station 141 may be connected to an input port of the first work station 110. In addition, a discharge port of the second work station 120 may be connected to an input port of the second sub-rework station 142. The discharge port of the second sub-rework station 142 may be connected to the input port of the first sub-rework station 141 or the input port of the second work station 120.

In an embodiment, when the abnormality occurs in the first fixing member, the battery stack may be transported from the first work station 110 to the first rework station 140. In this case, the first rework station 140 may remove, from the transported battery stack, the first fixing member with the abnormality detected. The first rework station 140 may input, into the first work station 110, the battery stack from which the first fixing member with the detected abnormality has been removed.

In an embodiment, when the abnormality occurs in the second fixing member, the battery stack may be transported from the second work station 120 to the first rework station 140. In this case, the first rework station 140 may, from the transported battery stack, remove the second fixing member with the abnormality detected. In this case, for example, the first rework station 140 may input the battery stack, from which the second fixing member with the detected abnormality has been removed, into the first work station 110 through the first sub-rework station 141. As another example, the first rework station 140 may input the battery stack, from which the second fixing member with the detected abnormality has been removed, into the second work station 120.

Hereinafter, specific embodiments of the present disclosure will be described with reference to the following drawings together with FIG. 1.

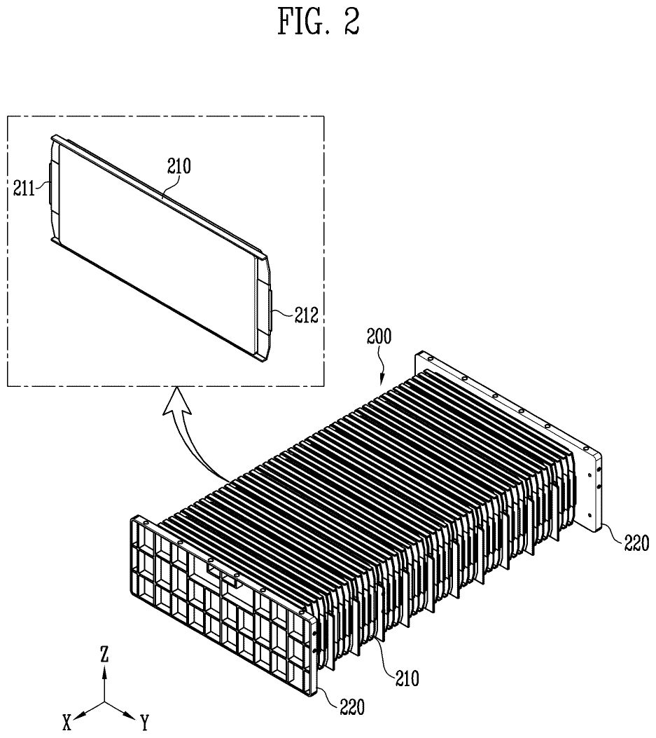

FIG. 2 is a diagram illustrating a battery stack input into a first work station according to an embodiment.

Referring to FIGS. 1 and 2, a battery stack 200 may be input into the first work station 110. The battery stack 200 may include a plurality of battery cells 210 and endplates 220. In other words, the battery stack 200 may be a stack in which the plurality of battery cells 210 and the endplates 220 are stacked in one direction. For example, the plurality of battery cells 210 may be stacked in an X-axis direction. The endplates 220 may be disposed in both sides of the plurality of battery cells 210 along the stacking direction of the battery cells 210. In other words, between the two endplates 220, the plurality of battery cells 210 may be disposed.

The battery cell 210 may include an electrode assembly, electrode tabs 211 and 212, electrolyte, and an exterior case. The electrode assembly may include a cathode and an anode. In an embodiment, the electrode assembly may further include a separator that prevents contact between the anode and cathode. The exterior case may be made of various types of materials and shapes, such as a pouch type, a prismatic type, and a cylindrical type. The exterior case may wrap the electrode assembly and wrap at least a part of the electrode tabs 211 and 212. In this case, an inner space sealed by the exterior case may accommodate at least a part of the electrode tabs 211 and 212, the electrode assembly, and the electrolyte. The electrode tabs 211 and 212 may protrude in one direction of the battery cell 210. The protruding direction of the electrode tabs 211 and 212 may be perpendicular to the stacking direction of the battery cells 210. For example, the protruding direction of the electrode tabs 211 and 212 may be a Y-axis direction, and the stacking direction of the battery cells 210 may be the X-axis direction. The electrode tabs 211 and 212 may include the first electrode tab 211 connected to the cathode of the electrode assembly and the second electrode tab 212 connected to the anode of the electrode assembly. The first electrode tab 211 and the second electrode tab 212 may be disposed at different ends as shown in FIG. 2, but unlike FIG. 2, they may be modified to be disposed at the same side end.

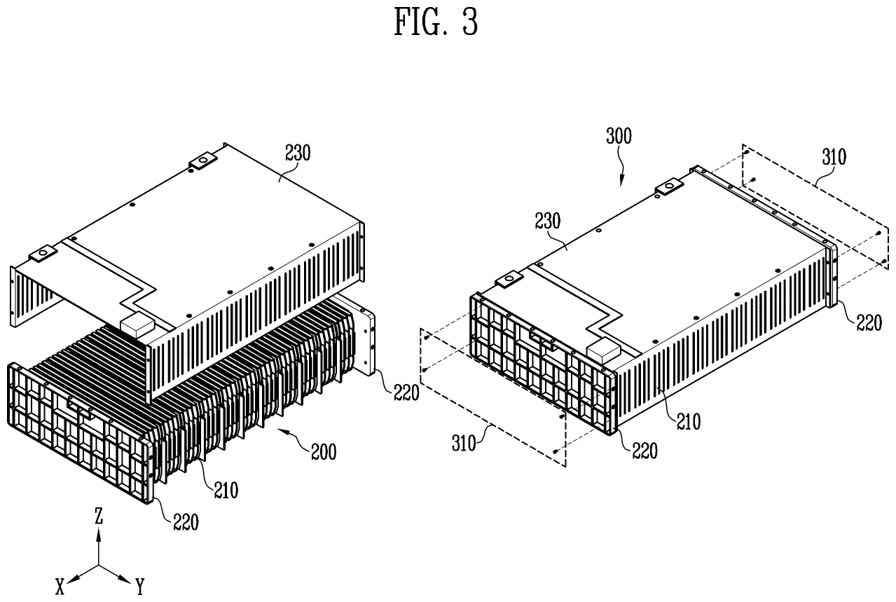

FIG. 3 is a diagram illustrating a coupling between a battery stack and a busbar assembly according to an embodiment. A battery stack 300 illustrated on the right of FIG. 3 shows a coupling of the battery stack 200 and a busbar assembly 230 illustrated on the left of FIG. 3.

Referring to FIGS. 1 to 3, when the battery stack 200 is input, the first work station 110 may couple the endplate 220 of the battery stack 200 to the busbar assembly 230 by using a first fixing member 310. In an embodiment, the first work station 110 may input the battery stack 300 into the second work station 120 if no abnormality is detected in a coupling state of the first fixing member 310. In an embodiment, the first work station 110 may input the battery stack 300 into the first rework station 140 when an abnormality is detected in the coupling state of the first fixing member 310.

In a specific embodiment, the first work station 110 may include a first assembly station 111 and a first inspection station 113. In an embodiment, the first work station 110 may further include a welding station 115.

The first assembly station 111 may couple the endplate 220 to the busbar assembly 230 by using the first fixing member 310. The first fixing member 310 may be a bolt, screw, or the like. By the first assembly station 111, the endplate 220 may be disposed on one side of the battery stack 200, and the busbar assembly 230 may be disposed at least on one of the other side of the battery stack 200. Here, the one side may indicate a positional relationship in a stacking direction of the battery cells 210, and the other side may indicate a positional relationship in a protruding direction of the electrode tabs 211 and 212 of the battery cell 210. For example, the stacking direction of the battery cells 210 may be the X-axis direction, and the protruding direction of the electrode tabs 211 and 212 may be the Y-axis direction. The busbar assembly 230 may be electrically connected to the electrode tabs 211 and 212 of each of the plurality of battery cells 210. The busbar assembly 230 may include a conductive material for electrically connecting the plurality of battery cells 210 to each other. In an embodiment, the busbar assembly 230 may be implemented in a shape of wrapping the other side and an upper part of the battery stack 200.

In an embodiment, the first assembly station 111 may include a fastening station 111a. In an embodiment, the first assembly station 111 may further include a sensor 111b.

Into the fastening station 111a of the first assembly station 111, the battery stack 200 and the busbar assembly 230 may be input. The fastening station 111a may dispose the busbar assembly 230 on the other side of the battery stack 200. The fastening station 111a may perform a fastening operation that fastens the first fixing member 310 at a fastening position of the endplate 220 of the battery stack 200 and the busbar assembly 230. For example, in each of the endplates 220 and the busbar assembly 230, a hole may be formed in an overlapping area. Here, the hole may correspond to the fastening position. The fastening station 111a may be aligned so that the holes of the endplate 220 and the busbar assembly 230 overlap in one direction (e.g., in the X-axis direction). The fastening station 111a may insert the first fixing member 310 into the overlapping holes in one direction (e.g., in the X-axis direction), and may fasten the first fixing member 310 with a set torque. The fastening station 111a may input, into the first inspection station 113, the battery stack 300 including the busbar assembly 230 coupled thereto.

The first inspection station 113 may inspect the coupling state of the first fixing member 310 of the battery stack 300 transported from the first assembly station 111. In an embodiment, the first inspection station 113 may include at least one of a linear variable differential transformer (LVDT) sensor, a laser displacement sensor, or a nutrunner controller. The first inspection station 113 may input, into the welding station 115, the battery stack 300 that has been completely inspected. In an embodiment, the first inspection station 113 may output a signal indicating whether an abnormality is detected in the coupling state of the first fixing member 310 and a signal indicating the fastening position of the first fixing member 310 where the abnormality is detected.

In an embodiment, the coupling state of the first fixing member 310 may include at least one of a fastening height, a fastening torque, or a fastening angle of the first fixing member 310 that is fastened. Here, the fastening height may be a difference between a height of a reference plane and a height of a protruding surface (e.g., a head surface) of the fastened first fixing member 310. For example, the first inspection station 113 may determine that an abnormality exists in the coupling state of the first fixing member 310 when the fastening height is beyond a reference range. The upper and lower limits of the reference range may be set in advance. The fastening angle may indicate an angle between the reference plane and the first fixing member 310 that is fastened. For example, the first inspection station 113 may determine that an abnormality exists in the coupling state of the first fixing member 310 when the fastening angle is beyond a reference range. The upper and lower limits of the reference range may be set in advance. The fastening torque may indicate a torque required to fasten the first fixing member 310. For example, the first inspection station 113 may determine that an abnormality exists in the coupling state of the first fixing member 310 when the fastening torque is beyond a reference range. The upper and lower limits of the reference range may be set in advance.

The welding station 115 may perform a welding operation to weld the bus bar 230 so that the battery stack 300 and the busbar assembly 230 are coupled to each other, when no abnormality is detected in the coupling state of the first fixing member 310. When the welding operation is performed, the electrode tab of the battery stack 300 may be electrically connected to the busbar assembly 230. The welding station 115 may input the battery stack 300 to which the welding operation has been performed into the second work station.

When an abnormality is detected in the coupling state of the first fixing member 310, the welding station 115 may not perform the welding operation for the battery stack 300. The welding station 115 may input the battery stack 300 into the first rework station 140.

In addition, the welding station 115 according to an embodiment may further include a welding inspection station. The welding inspection station may determine whether the welding operation is defective or not. For example, the weld inspection station may include a vision camera. The welding inspection station may obtain an image by capturing the bus bar 230 to which the welding operation has been performed and determine whether the welding operation is defective through the image. If the welding operation is defective, the first work station 110 may treat the battery stack 300 as defective so that the battery stack 300 is not reinput into the first work station 110 through the first rework station 140.

In an embodiment, when an abnormality exists in the coupling state of the first fixing member 310, the battery stack 300 may be transported from the first work station 110 to the first sub-rework station 141 of the first rework station 140. The first sub-rework station 141 may remove the first fixing member 310 in which the abnormality is detected from the battery stack 300. For example, the first sub-rework station 141 may identify a fastening position of the first fixing member 310 in which the abnormality is detected, based on the signal indicating the fastening position output from the first inspection station 113. The first sub-rework station 141 may remove the first fixing member 310 inserted in advance into the identified fastening position. The first sub-rework station 141 may input the battery stack 300 from which the first fixing member 310 has been removed, into the first work station 110. In an embodiment, the first sub-rework station 141 may be implemented as a robot to remove a fixing member.

When the battery stack 300 is transported to the first assembly station 111 of the first work station 110, the sensor 111b of the first assembly station 111 may detect whether the first fixing member 310 inserted in advance into the fastening position of the first fixing member 310 exists. In an embodiment, the sensor 111b may detect whether the first fixing member 310 inserted in advance into the fastening position of the first fixing member 310 exists before a fastening operation is performed by the fastening station 111a. For example, the first fixing member 310 inserted in advance may be a fixing member in which an abnormality has been detected and which has not been removed by the first rework station 140. In an embodiment, the sensor 111b may be implemented as a cylinder sensor, or the like.

In an embodiment, the fastening station 111a of the first assembly station 111 may perform a fastening operation to fasten a new first fixing member 310 corresponding to the fastening position when the first fixing member 310 inserted in advance does not exist at the fastening position at which the first fixing member 310 is to be fastened. The fastening station 111a may input the battery stack 300 for which the fastening operation is performed into the first inspection station 113.

In an embodiment, the fastening station 111a of the first assembly station 111 may not perform a fastening operation to fasten the new first fixing member 310 corresponding to the fastening position when the first fixing member 310 inserted in advance exists at the fastening position. The fastening station 111a may bypass the battery stack 300 and input the same into the first rework station 140. Here, “bypass” may mean omitting a subsequent operation (e.g., an inspection operation, a welding operation, or the like) in the first work station 110 performed for the battery stack 300 and discharging the battery stack 300 through the discharge port of the first work station 110.

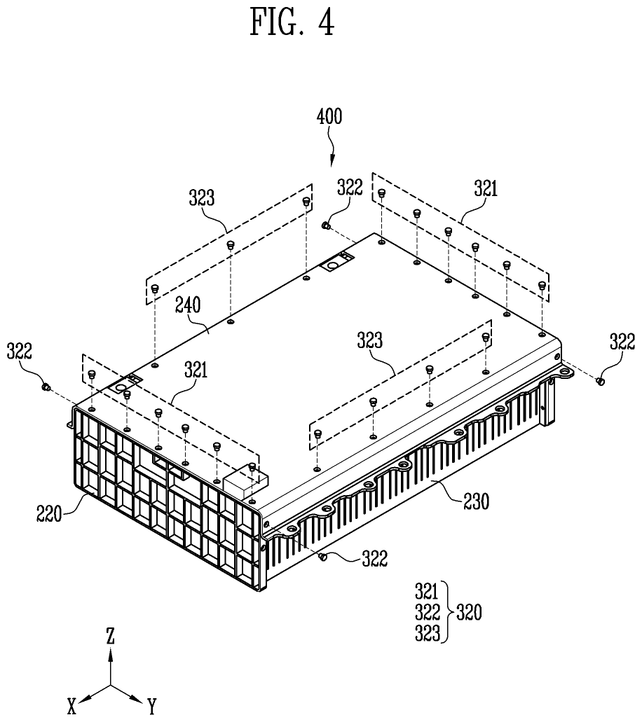

FIG. 4 is a diagram illustrating a coupling between a battery stack and an upper cover according to an embodiment.

Referring to FIGS. 1 to 4, the second work station 120 may couple an upper cover 240 and at least one of the endplate 220 of the battery stack 300 or the busbar assembly 230 by using a second fixing member 320 when the battery stack 300 is input. In an embodiment, the second work station 120 may input a battery stack 400 into the reversing station 160 when no abnormality is detected in a coupling state of the second fixing member 320. In an embodiment, the second work station 120 may input the battery stack 400 into the first rework station 140 when an abnormality is detected in the coupling state of the second fixing member 320.

Specifically, the second work station 120 may include a second assembly station 121 and a second inspection station 123.

The second assembly station 121 may couple at least one of the endplates 220 or the busbar assembly 230 to the upper cover 240 by using the second fixing member 320. The second fixing member 320 may be a bolt, a screw, or the like. By the second assembly station 121, the upper cover 240 may be disposed in an upper part of the battery stack 300. Here, the upper part may represent a positional relationship in a height direction. For example, the height direction may be a Z-axis direction. In an embodiment, the upper cover 240 may have a shape of wrapping the upper part of the battery stack 400 and at least a part of the other side.

In an embodiment, the second assembly station 121 may include a fastening station 121a. In an embodiment, the second assembly station 121 may further include a sensor 121b.

The battery stack 300 and the upper cover 240 may be input into the fastening station 121a of the second assembly station 121. The fastening station 121a may dispose the upper cover 240 in the upper part of the battery stack 300. The fastening station 121a may perform a fastening operation to fasten the second fixing member 320 at a fastening position where at least one of the endplate 220 or the busbar assembly 230 of the battery stack 300 and the upper cover 240 are fastened. For example, a hole may be formed in an area where at least one of the endplate 220 or the busbar assembly 230 and the upper cover 240 overlap. Here, the hole may correspond to the fastening position. The fastening station 121a may input, into the second inspection station 123, the battery stack 400 including the upper cover 240 coupled thereto.

In a specific embodiment, the fastening station 121a of the second assembly station 121 may align the upper cover 240 so that the holes of the endplate 220 and the upper cover 240 overlap. For example, the fastening station 121a may insert a (2-1)^{th} fixing member 321 in a height direction (e.g., in the Z-axis direction) into holes in a first overlapping area of the endplate 220 and the upper cover 240 and fasten the same with a set torque. For example, the fastening station 121a may insert a (2-2)^{th} fixing member 322 in a horizontal direction (e.g., in the Y-axis direction) into holes in a second overlapping area of the endplate 220 and the upper cover 240 and fasten the same with a set torque.

In an embodiment, the fastening station 121a of the second assembly station 121 may align the upper cover 240 so that the holes of the busbar assembly 230 and the upper cover 240 overlap. For example, the fastening station 121a may insert a (2-3)^{th} fixing member 323 in the height direction (e.g., in the Z-axis direction) into holes in a third overlapping area of the busbar assembly 230 and the upper cover 240 and fasten the same with a set torque.

The second inspection station 123 may inspect a coupling state of the second fixing member 320 of the battery stack 400 transported from the second assembly station 121. In an embodiment, the second inspection station 123 may include at least one of a linear variable differential transformer (LVDT) sensor, a laser displacement sensor, or a nutrunner controller.

In an embodiment, the coupling state of the second fixing member 320 may include at least one of a fastening height, a fastening torque, or a fastening angle of the fastened second fixing member 320. Here, descriptions of the fastening height, the tightening torque, and the fastening angle are omitted because they overlap with the above descriptions.

In an embodiment, the second inspection station 123 may input the battery stack 400 into the first rework station 140 when an abnormality is detected in the coupling state of the second fixing member 320. In another embodiment, the second inspection station 123 may input the battery stack 400 into the reversing station 160 when no abnormality is detected in the coupling state of the second fixing member 320.

In an embodiment, when an abnormality exists in the coupling state of the second fixing member 320, the battery stack 400 may be transported from the second work station 120 to the second sub-rework station 142 of the first rework station 140. The second sub-rework station 142 may remove the second fixing member 320 in which the abnormality is detected from the battery stack 400. For example, the second sub-rework station 142 may identify a fastening position of the second fixing member 320 in which the abnormality is detected, based on a signal indicating the fastening position output from the second inspection station 123. The second sub-rework station 142 may remove the second fixing member 320 inserted in advance from the identified fastening position. In an embodiment, the second sub-rework station 142 may be implemented as a robot to remove a fixing member.

In an embodiment, the second inspection station 123 may output a signal indicating whether an abnormality is detected in the coupling state of the second fixing member 320 and a signal indicating a fastening position of the second fixing member 320 in which an abnormality is detected.

In an embodiment, the second sub-rework station 142 may input the battery stack 400 from which the second fixing member 320 has been removed into the first work station 110 through the first sub-rework station 141. The sensor 111b of the first assembly station 111 or the first inspection station 113 may detect whether an abnormality exists in the coupling state of the first fixing member 310 of the battery stack 400 that is input into the first work station 110. When no abnormality exists in the coupling state of the first fixing member 310 of the battery stack 400, the first work station 110 may input the battery stack 400 into the second work station 120. When an abnormality exists in the coupling state of the first fixing member 310 of the battery stack 400, the first work station 110 may input the battery stack 400 into the first rework station 140.

In another embodiment, the second sub-rework station 142 may input the battery stack 400 from which the second fixing member 320 has been removed into the second work station 120.

When the battery stack 400 is transported to the second assembly station 121 of the second work station 120, the sensor 121b of the second assembly station 121 may detect whether the second fixing member 320 inserted in advance exists at the fastening position of the second fixing member 320. In an embodiment, the sensor 121b may detect whether the second fixing member 320 inserted in advance exists at the fastening position of the second fixing member 320 before a fastening operation is performed by the fastening station 121a. For example, the first fixing member 320 inserted in advance may be a fixing member in which an abnormality has been detected and which has not been removed by the first rework station 140. In an embodiment, the sensor 121b may be implemented as a cylinder sensor, a vision camera, or the like.

In an embodiment, the sensor 121b may acquire an image by capturing the fastening position. The sensor 121b may input the acquired image into a trained AI model, and determine, based on an output value of the trained AI model, whether the second fixing member 320 inserted in advance exists at the fastening position. For example, the sensor 121b may determine that the second fixing member 320 inserted in advance exists at the fastening position when the output value of the trained AI model is greater than a reference value (e.g., 0.5). For example, the sensor 121b may determine that the second fixing member 320 inserted in advance does not exist at the fastening position when the output value of the trained AI model is less than the reference value (e.g., 0.5). For example, the trained AI model may be pre-trained so that a first value (e.g., 1) is output when a first image is input into the AI model, and a second value (e.g., 0) is output when a second image is input into the AI model. The first image may be an image obtained in advance by capturing the second fixing member 320 that is in the state of being inserted into the fastening position. The second image may be an image obtained in advance by capturing the second fixing member 320 that is in the state of not being inserted into the fastening position.

In an embodiment, the fastening station 121a of the second assembly station 121 may perform a fastening operation to fasten a new second fixing member 320 corresponding to the fastening position when the second fixing member 320 inserted in advance does not exist at the fastening position where the second fixing member 320 is to be fastened. The fastening station 121a may input, into the second inspection station 123, the battery stack 400 for which the fastening operation is performed.

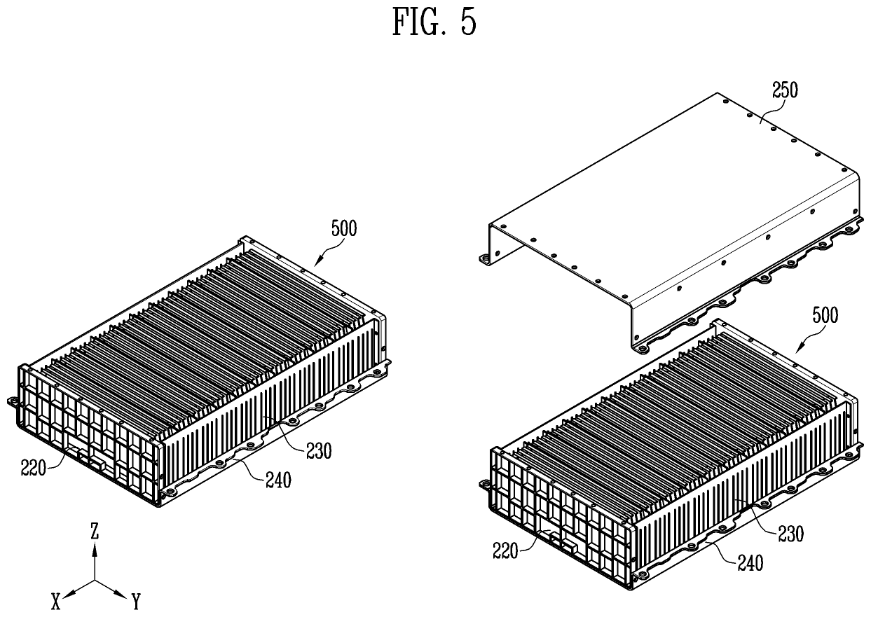

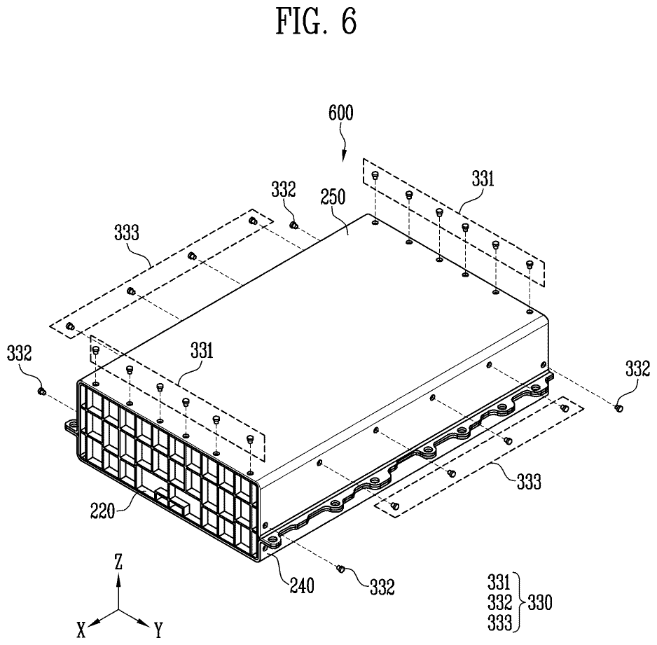

In an embodiment, the fastening station 121a of the second assembly station 121 may not perform the fastening operation when the second fixing member 320 inserted in advance exists at the fastening position. The fastening station 121a may bypass the battery stack 400 and input the same into the first rework station 140. Here, “bypass” may refer to omitting the operation (e.g., the fastening operation, inspection operation, or the like.) in the second work station 120 performed for the battery stack 400 and discharging the battery stack 400 through the discharge port of the second work station 120. FIGS. 5 and 6 are drawings illustrating a coupling between a reversed battery stack and a lower cover according to embodiments.

Referring to FIGS. 1 to 5, the battery assembly device 100 according to an embodiment of the present disclosure may further include the reversing station 160 and a third work station 130. In an embodiment, the battery assembly device 100 may further include the second rework station 150.

When the battery stack 400 is transported from the second work station 120, the reversing station 160 may enable the battery stack 400 to be reversed so that a lower surface of the battery stack 400 faces upward. In other words, the lower surface of the battery stack 400 may be rotated to become an upper surface. For example, the reversing station 160 may reverse the battery stack 400 by 180 degrees. A battery stack 500 of FIG. 5 illustrates the battery stack 400 of FIG. 4 that is reversed. In an embodiment, the reversing station 160 may be implemented as a robot capable of performing a rotational motion. The reversing station 160 may input the reversed battery stack 500 into the third work station 130.

Referring to FIGS. 1 to 6, when the reversed battery stack 500 is transported, the third work station 130 may couple at least one of the endplate 220 or the busbar assembly 230 of the reversed battery stack 500 to a lower cover 250 by using a third fixing member 330. In an embodiment, the third work station 130 may input a battery stack 600 including the lower cover 250 coupled thereto into a subsequent process equipment when no abnormality is detected in a coupling state of the third fixing member 330. In another embodiment, the third work station 130 may input the battery stack 600 including the lower cover 250 coupled thereto into the second rework station 150 when an abnormality is detected in the coupling state of the third fixing member 330.

Specifically, the third work station 130 may include a third assembly station 131 and a third inspection station 133. The third assembly station 131 may couple at least one of the endplate 220 or the busbar assembly 230 to the lower cover 250 by using the third fixing member 330. The third assembly station 131 may input the battery stack 600 including the lower cover 250 coupled thereto, into the third inspection station 133.

In an embodiment, the third assembly station 131 may include a fastening station 131a. In an embodiment, the third assembly station 131 may further include a sensor 131b.

The battery stack 500 that is reversed and the lower cover 250 may be input into the fastening station 131a of the third assembly station 131. The fastening station 131a may dispose the lower cover 250 in an upper part of the reversed battery stack 500. In an embodiment, the lower cover 250 may have a shape of wrapping the upper part of the reversed battery stack 500 and at least a part of the other side. Here, the upper cover 240 of the battery stack 500 may have a shape of wrapping a lower part of the reversed battery stack 500 and at least a part of the remaining part of the other side.

The fastening station 131a of the third assembly station 131 may perform a fastening operation to fasten the third fixing member 330 at the fastening position where at least one of the endplate 220 or the busbar assembly 230 and the lower cover 250 are fastened. For example, a hole may be formed in an overlapping area where at least one of the endplate 220 or the busbar assembly 230 and the lower cover 250 overlap. Here, the hole may correspond to the fastening position. The fastening station 131a may input, into the third inspection station 133, the battery stack 600 including the lower cover 250 coupled thereto.

In a specific embodiment, the fastening station 131a of the third assembly station 131 may align the lower cover 250 so that the holes of the endplate 220 and the lower cover 250 overlap. For example, the fastening station 131a may insert a (3-1)^{th} fixing member 331 in a height direction (e.g., in the Z-axis direction) into holes in a first overlapping area of the endplate 220 and the lower cover 250, and fasten the same with a set torque. For example, the fastening station 131a may insert a (3-2)^{th} fixing member 332 in a horizontal direction (e.g., in the Y-axis direction) into holes in a second overlapping area of the endplate 220 and the lower cover 250, and fasten the same with a set torque.

In an embodiment, the fastening station 131a of the second assembly station 121 may align the lower cover 250 so that the holes of the busbar assembly 230 and the lower cover 250 overlap. For example, the fastening station 131a may insert a (3-3)^{th} fixing member 333 in the horizontal direction (e.g., in the Y-axis direction) into holes of a third overlapping area of the busbar assembly 230 and the lower cover 250 and fasten the same with a set torque.

The third inspection station 133 may inspect the coupling state of the third fixing member 330 of the battery stack 600 transported from the third assembly station 131. In an embodiment, the third inspection station 133 may include at least one of a linear variable differential transformer (LVDT) sensor, a laser displacement sensor, or a nutrunner controller.

In an embodiment, the coupling state of the third fixing member 330 may include at least one of a fastening height, a fastening torque, or a fastening angle of the second fixing member 320 fastened. Here, descriptions of the fastening height, the tightening torque, and the fastening angle are omitted because they overlap with the above descriptions.

In an embodiment, the third inspection station 133 may input the battery stack 600 into the second rework station 150 when an abnormality is detected in the coupling state of the third fixing member 330. In another embodiment, the third inspection station 133 may input the battery stack 600 into the subsequent process equipment when no abnormality is detected in the coupling state of the third fixing member 330.

In an embodiment, the third inspection station 133 may output a signal indicating whether an abnormality is detected in the coupling state of the third fixing member 330 and a signal indicating the fastening position of the third fixing member 330 in which an abnormality is detected.

In an embodiment, when the battery stack 600 is transported from the third work station 130, the second rework station 150 may remove, from the battery stack 600, the third fixing member 330 with the abnormality detected. In an embodiment, the second rework station 150 may be implemented as a robot that removes a fixing member. The second rework station 150 may input, into the third work station 130, the battery stack 600 from which the third fixing member 330 with the abnormality detected has been removed.

In an embodiment, when the battery stack 600 is transported to the third assembly station 131 of the third work station 130, the sensor 131b of the third assembly station 131 may detect whether the third fixing member 330 inserted in advance exists at the fastening position of the third fixing member 330. In an embodiment, the sensor 131b may detect whether the third fixing member 330 inserted in advance exists at the fastening position of the third fixing member 330 before a fastening operation is performed by the fastening station 131a. For example, the third fixing member 330 inserted in advance may be a fixing member in which an abnormality has been detected and which has not been removed by the second rework station 150. In an embodiment, the sensor 121b may be implemented as a cylinder sensor, a vision camera, or the like.

In an embodiment, the fastening station 131a of the third assembly station 131 may perform a fastening operation to fasten a new third fixing member 330 corresponding to the fastening position when the third fixing member 330 inserted in advance does not exist at the fastening position where the third fixing member 330 is to be fastened. The fastening station 131a may input the battery stack 600 for which the fastening operation is performed into the third inspection station 133.

In an embodiment, the fastening station 131a of the third assembly station 131 may not perform a fastening operation when the third fixing member 330 inserted in advance does not exist at the fastening position. The fastening station 131a may bypass the battery stack 600 and may input the same into the second rework station 150. Here, “bypass” may refer to omitting the operation (e.g., the fastening operation, the inspection operation, or the like) in the third work station 130 performed for the battery stack 600 and discharging the battery stack 600 through the discharge port of the third work station 130.

What is claimed is:

1. A battery assembly device comprising:
a first work station configured to couple an endplate to a busbar assembly using a first fixing member, wherein the endplate is disposed on one side of a battery stack in which a plurality of battery cells are stacked and the busbar assembly is disposed at least on one of the other sides of the battery stack;
a second work station configured to couple, using a second fixing member, at least one of the endplate or the busbar assembly of the battery stack transported from the first work station to an upper cover disposed in an upper part of the battery stack; and
a first rework station configured to:
when an abnormality is detected in a coupling state of at least one fixing member of the first fixing member or the second fixing member, remove the first or second fixing members having the abnormality detected from the battery stack transported from the first work station or the second work station, and
input the battery stack into the first work station or the second work station.

2. The battery assembly device according to claim 1, wherein the coupling state comprises at least one of a fastening height, a fastening torque, or a fastening angle.

3. The battery assembly device according to claim 1, wherein the first work station comprises:
a first assembly station configured to couple the endplate to the busbar assembly by using the first fixing member; and
a first inspection station configured to inspect the coupling state of the first fixing member of the battery stack transported from the first assembly station.

4. The battery assembly device according to claim 3, wherein the first work station further comprises a welding station configured to:
perform a welding operation to weld the busbar assembly so that the battery stack and the busbar assembly are coupled together when no abnormality is detected in the coupling state of the first fixing member; and
not perform the welding operation when an abnormality is detected in the coupling state of the first fixing member.

5. The battery assembly device according to claim 3, wherein the first work station is configured to:
input the battery stack into the second work station when no abnormality is detected in the coupling state of the first fixing member; and
input the battery stack into the first rework station when an abnormality is detected in the coupling state of the first fixing member.

6. The battery assembly device according to claim 3, wherein the second work station comprises:
a second assembly station configured to couple at least one of the endplate or the busbar assembly to the upper cover by using the second fixing member; and
a second inspection station configured to inspect the coupling state of the second fixing member of the battery stack transported from the second assembly station.

7. The battery assembly device according to claim 6, wherein each of the first assembly station and the second assembly station comprises:
a sensor configured to detect whether a fixing member exists at a fastening position of the first or the second fixing members in which an abnormality is detected; and
a fastening station configured to perform a fastening operation to fasten a corresponding fixing member in the fastening position when the fixing member does not exist at the fastening position.

8. The battery assembly device according to claim 7, wherein the fastening station is configured to:
bypass the battery stack without performing the fastening operation, and
input the battery stack into the first rework station when the fixing member exists at the fastening position.

9. The battery assembly device according to claim 1, wherein the first rework station comprises:
a first sub-rework station configured to:
when an abnormality is detected in the coupling state of the first fixing member, remove, from the battery stack transported from the first work station, the first fixing member having the abnormality detected, and
input, into the first work station, the battery stack from which the first fixing member having the abnormality detected is removed; and
a second sub-rework station configured to:
when an abnormality is detected in the coupling state of the second fixing member, remove, from the battery stack transported from the second work station, the second fixing member having the abnormality detected, and
input, into the first work station or the second work station, the battery stack from which the second fixing member having the abnormality detected is removed.

10. The battery assembly device according to claim 1, further comprising:
a reversing station configured to reverse the battery stack so that a lower surface of the battery stack transported from the second work station faces upward; and
a third work station configured to couple, using a third fixing member, at least one of the endplate or the busbar assembly to a lower cover disposed in an upper part of the reversed battery stack.

11. The battery assembly device according to claim 10, further comprising a second rework station configured to:
when an abnormality is detected in a coupling state of the third fixing member, remove, from the reversed battery stack, the third fixing member having the abnormality detected, and
input, into the third work station, the reversed battery stack from which the third fixing member having the abnormality detected is removed.

12. The battery assembly device according to claim 11, wherein the third work station comprises:
a third assembly station configured to couple, using the third fixing member, at least one of the endplate or the busbar assembly to the lower cover; and
a third inspection station configured to inspect the coupling state of the third fixing member of the battery stack transported from the third assembly station.

13. The battery assembly device according to claim 12, wherein the third assembly station comprises:
a sensor configured to detect whether a fixing member exists at a fastening position of the third fixing member having an abnormality detected; and
a fastening station configured to perform a fastening operation to fasten the third fixing member at the fastening position when no fixing member exists at the fastening position.

14. The battery assembly device according to claim 13, wherein the fastening station is configured to:
bypass the battery stack without performing the fastening operation, and
input the battery stack into the second rework station when the fixing member exists at the fastening position.

15. A method for assembling a battery, the method comprising:
coupling an endplate disposed on one side of a battery stack in which a plurality of battery cells are stacked to a busbar assembly disposed at least on one of the other sides of the battery stack using a first fixing member;
coupling at least one of the endplate or the busbar assembly of the battery stack transported from the first work station to an upper cover disposed in an upper part of the battery stack using a second fixing member;
detecting an abnormality in a coupling state of one or both of the first and second fixing members;
removing the battery stack from one or both of the first and second fixing members;
removing one or both of the first and second fixing members based on where the abnormality is detected; and
inputting the battery stack into one or both of the first and second fixing members when no abnormality is detected.

16. A system for assembling a battery, the system comprising:
first means for coupling an endplate disposed on one side of a battery stack in which a plurality of battery cells are stacked to a busbar assembly disposed at least on one of the other sides of the battery stack;
second means for coupling at least one of the endplate or the busbar assembly of the battery stack transported from the first workstation to an upper cover disposed in an upper part of the battery stack; and
means for detecting an abnormality in a coupling state of one or both of the first and second means for coupling,
wherein the coupling state comprises at least one of a fastening height, a fastening torque, or a fastening angle of the of a fixing member of the first or second means for coupling.
